(19) United States
(12) Patent Application Publication
(10) Pub. No.: US 2024/0393194 A1
(43) Pub. Date: Nov. 28, 2024

(54) SENSOR

(71) Applicant: Murata Manufacturing Co., Ltd., Nagaokakyo-shi (JP)

(72) Inventors: Shingo HARADA, Nagaokakyo-shi (JP); Yoshihito OKUTOMI, Nagaokakyo-shi (JP)

(21) Appl. No.: 18/790,265

(22) Filed: Jul. 31, 2024

Related U.S. Application Data
(63) Continuation of application No. PCT/JP2023/004161, filed on Feb. 8, 2023.

(30) Foreign Application Priority Data
Feb. 10, 2022 (JP) 2022-019245

(51) Int. Cl. G01L 1/16; G06F 3/01

(52) U.S. Cl. CPC G01L 1/16; G06F 3/01

(57) ABSTRACT

A sensor that includes: a piezoelectric film including an upper principal surface and a lower principal surface aligned in an up-down direction; a first electrode on the upper principal surface of the piezoelectric film; a second electrode on the lower principal surface of the piezoelectric film; and a first cured resin layer covering at least a part of the second electrode as viewed in the up-down direction.

### CROSS REFERENCE TO RELATED APPLICATIONS

The present application is a continuation of International application No. PCT/JP2023/004161, filed Feb. 8, 2023, which claims priority to Japanese Patent Application No. 2022-019245, filed Feb. 10, 2022, the entire contents of each of which are incorporated herein by reference.

### TECHNICAL FIELD

The present disclosure relates to a sensor that detects a pressing force.

### BACKGROUND ART

As an disclosure related to a conventional sensor, for example, a pressing sensor described in Patent Document 1 is known. The pressing sensor includes a piezoelectric film, a second electrode, and a third electrode. The second electrode is fixed to an upper principal surface of the piezoelectric film with a bonding layer interposed therebetween. The third electrode is fixed to a lower principal surface of the piezoelectric film with a bonding layer interposed therebetween. When pressed downward, the piezoelectric film extends in a left-right direction. When the piezoelectric film is stretched in the left-right direction, a charge is generated. As a result, a detection signal according to a pressing force is output from the second electrode. The pressing sensor as described above is attached to a display panel of an electronic device.

Patent Document 1: WO 2020/129346 A

### SUMMARY OF THE DISCLOSURE

Meanwhile, in the pressing sensor described in Patent Document 1, when a pressing force is repeatedly applied to the pressing sensor, a force is repeatedly applied to the pressing sensor and a member that fixes the pressing sensor to a display panel. Therefore, from the viewpoint of preventing failure of the pressing sensor, it is desired to improve the rigidity of the pressing sensor.

Therefore, an object of the present disclosure is to provide a sensor having high rigidity.

A sensor according to an embodiment of the present disclosure includes: a piezoelectric film including an upper principal surface and a lower principal surface aligned in an up-down direction; a first electrode on the upper principal surface of the piezoelectric film; a second electrode on the lower principal surface of the piezoelectric film; and a first cured resin layer covering at least a part of the second electrode as viewed in the up-down direction.

According to the sensor of the present disclosure, the rigidity of the sensor can be improved.

### BRIEF EXPLANATION OF THE DRAWINGS

FIG. 1 is an exploded perspective view of an electronic device 1.

FIG. 2 is a sectional view of the electronic device 1 taken along line A-A.

FIG. 3 is a bottom view and a sectional view of a sensor 6.

FIG. 4 is a sectional view of the sensor 6.

FIG. 5 is a sectional view of a sensor 6a.

FIG. 6 is a sectional view of a sensor 6b.

FIG. 7 is a sectional view of a sensor 6c.

### DESCRIPTION OF THE PREFERRED EMBODIMENTS

### Embodiment

### Structure of Electronic Device

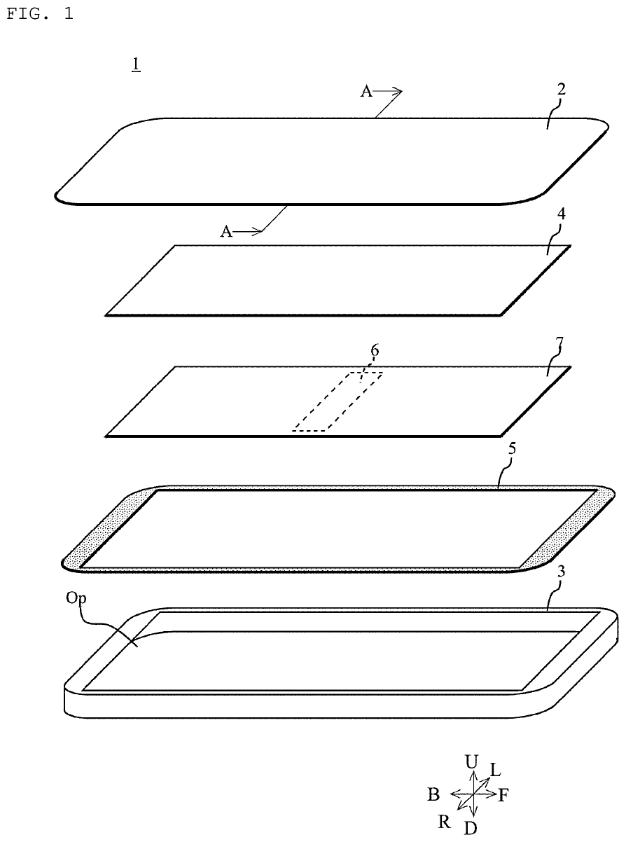

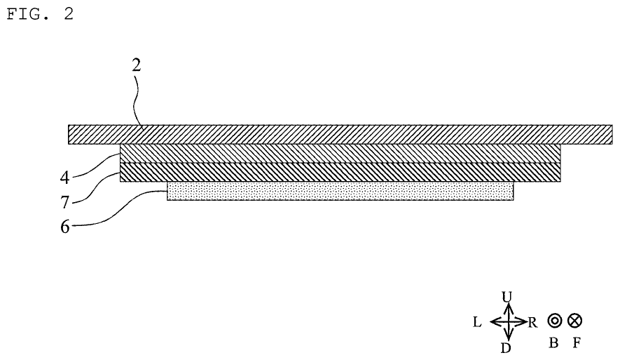

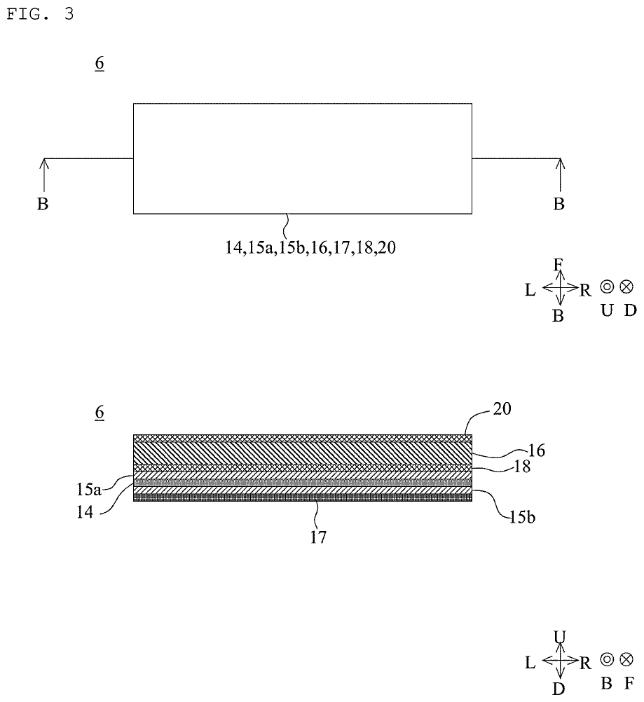

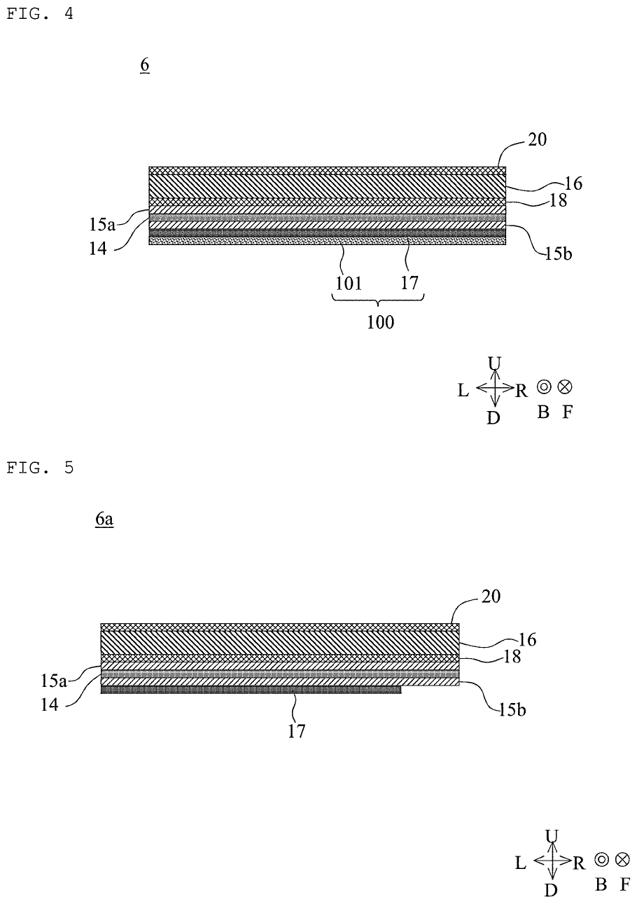

Hereinafter, a configuration of an electronic device 1 including a sensor 6 according to an embodiment of the present disclosure will be described with reference to the drawings. FIG. 1 is an exploded perspective view of the electronic device 1. FIG. 2 is a sectional view of the electronic device 1 taken along line A-A. FIG. 3 is a bottom view and a sectional view of the sensor 6. FIG. 4 is a sectional view of the sensor 6.

Furthermore, in the present specification, directions are defined as described below. In the electronic device 1, a direction in which an upper principal surface and a lower principal surface of an operation panel 2 are aligned is defined as an up-down direction. Furthermore, when viewed in the up-down direction, a direction in which a long side of the operation panel 2 of the electronic device 1 extends is defined as a front-back direction. When viewed in the up-down direction, a direction in which a short side of the operation panel 2 of the electronic device 1 extends is defined as a left-right direction. The up-down direction, the left-right direction, and the front-back direction are orthogonal to each other. Note that the definition of the directions in the present specification is an example. Therefore, the direction at the time of actual use of the electronic device 1 does not need to coincide with the direction in the present specification. Furthermore, the up-down direction may be reversed in FIG. 1. In FIG. 1, the left-right direction may be reversed. The front-back direction may be reversed in FIG. 1.

The electronic device 1 is a portable electronic terminal such as a smartphone or a tablet computer. As illustrated in FIGS. 1 and 2, the electronic device 1 includes the operation panel 2, a housing 3, a display panel 4, a bonding member 5, the sensor 6, and a plate-shaped member 7.

The operation panel 2 includes an upper principal surface and a lower principal surface aligned in the up-down direction. The operation panel 2 has a rectangular shape having two long sides extending in the front-back direction and two short sides extending in the left-right direction when viewed in the up-down direction. A part of a user's body or an operation member comes into contact with the upper principal surface of the operation panel 2. The operation panel 2 is a transparent plate. The operation panel 2 is, for example, a glass plate.

The display panel 4 includes an upper principal surface and a lower principal surface aligned in the up-down direction. The display panel 4 has a rectangular shape having two long sides extending in the front-back direction and two short sides extending in the left-right direction when viewed in the up-down direction. The display panel 4 is fixed to the lower principal surface of the operation panel 2. The display panel 4 is fixed to the operation panel 2 with a bonding adhesive, a double-sided tape, or the like. The entire display panel 4 overlaps the operation panel 2 when viewed in the up-down direction. Therefore, the display panel 4 does not protrude from an outer edge of the operation panel 2 when viewed in the up-down direction. The display panel 4 is, for example, an organic EL display or a liquid crystal display. Furthermore, the display panel 4 may include a touch panel for detecting a position where the user touches the operation panel 2. However, the touch panel may be included in the operation panel 2.

The plate-shaped member 7 includes an upper principal surface and a lower principal surface aligned in the up-down direction. The plate-shaped member 7 has a rectangular shape having two long sides extending in the front-back direction and two short sides extending in the left-right direction when viewed in the up-down direction. The plate-shaped member 7 is fixed to the lower principal surface of the display panel 4. The plate-shaped member 7 is fixed to the display panel 4 with a bonding adhesive, a double-sided tape, or the like. The entire plate-shaped member 7 overlaps the display panel 4 when viewed in the up-down direction. Therefore, the plate-shaped member 7 does not protrude from an outer edge of the display panel 4 when viewed in the up-down direction. The rigidity of the plate-shaped member 7 is higher than the rigidity of the sensor 6 described later. The material of such a plate-shaped member 7 is, for example, metal such as stainless used steel (SUS). However, the material of the plate-shaped member 7 may be a material other than metal. The material other than the metal is, for example, a resin.

The housing 3 is located below the operation panel 2. The housing 3 is a box. The housing 3 has a rectangular shape when viewed in the up-down direction. A long side of the housing 3 extends in the front-back direction. A short side of the housing 3 extends in the left-right direction. An outer edge of the housing 3 viewed in the up-down direction coincides with the outer edge of the operation panel 2 viewed in the up-down direction. However, an upper face of the housing 3 is open. An opening Op of the housing 3 has a rectangular shape when viewed in the up-down direction.

The bonding member 5 fixes a part of the lower principal surface of the operation panel 2 to the housing 3. More specifically, the bonding member 5 fixes a periphery of the opening Op of the housing 3 and a vicinity of the outer edge of the operation panel 2. Thus, the bonding member 5 has a rectangular frame shape surrounding the display panel 4 when viewed in the up-down direction. Therefore, the bonding member 5 does not overlap the display panel 4 when viewed in the up-down direction. The bonding member 5 as described above has waterproofness.

The sensor 6 detects deformation of the operation panel 2. As illustrated in FIG. 1, the sensor 6 is fixed to the lower principal surface of the plate-shaped member 7. More specifically, the sensor 6 has a rectangular shape when viewed in the up-down direction. The sensor 6 has a longitudinal direction extending in the left-right direction. The sensor 6 is located at a center of the plate-shaped member 7 in the front-back direction as viewed in the up-down direction.

When the user presses the operation panel 2 to bend the operation panel 2 downward, the display panel 4 and the plate-shaped member 7 also bend downward. Then, the sensor 6 bends downward together with the plate-shaped member 7. As a result, the sensor 6 outputs a detection signal according to deformation generated on the operation panel 2 when the user presses the operation panel 2. Hereinafter, details of the sensor 6 will be described with reference to FIG. 3.

As illustrated in FIG. 3, the sensor 6 includes a piezoelectric film 14, a first electrode 15a, a second electrode 15b, a substrate 16, a first cured resin layer 17, and bonding layers 18 and 20. The piezoelectric film 14 has a sheet shape. Therefore, the piezoelectric film 14 includes an upper principal surface and a lower principal surface aligned in the up-down direction. A length of the piezoelectric film 14 in the left-right direction is longer than a length of the piezoelectric film 14 in the front-back direction. In the present embodiment, the piezoelectric film 14 has a rectangular shape having long sides extending in the left-right direction when viewed in the up-down direction. The piezoelectric film 14 generates a charge according to a deformation amount of the piezoelectric film 14. In the present embodiment, the piezoelectric film 14 is a PLA film. Hereinafter, the piezoelectric film 14 will be described in more detail.

The piezoelectric film 14 has a characteristic in which a polarity of the charge generated when the piezoelectric film 14 is stretched in the left-right direction is opposite to a polarity of the charge generated when the piezoelectric film 14 is stretched in the front-back direction. Specifically, the piezoelectric film 14 is a film formed of a chiral polymer. The chiral polymer is, for example, polylactic acid (PLA), particularly poly-L-lactic acid (PLLA). A main chain of the PLLA made of a chiral polymer has a helical structure. The PLLA has piezoelectricity in which molecules are oriented when uniaxial stretching is performed. The piezoelectric film 14 has a piezoelectric constant of d14. A uniaxial stretching direction (orientation direction) of the piezoelectric film 14 forms an angle of 45 degrees with respect to each of the front-back direction and the left-right direction. This angle of 45 degrees includes, for example, angles ranging from 45 degrees plus 10 degrees to 45 degrees minus 10 degrees. As a result, the piezoelectric film 14 generates a charge when the piezoelectric film 14 is stretched in the left-right direction or stretched in the front-back direction. A polarity of the charge generated by the piezoelectric film 14 when the piezoelectric film 14 is stretched in the left-right direction is different from a polarity of the charge generated by the piezoelectric film 14 when the piezoelectric film 14 is stretched in the front-back direction. The piezoelectric film 14 generates a positive charge when stretched in the left-right direction, for example. The piezoelectric film 14 generates a negative charge when stretched in the front-back direction, for example. A magnitude of the charge depends on an amount of deformation of the piezoelectric film 14 due to stretching or compression. More precisely, the magnitude of the charge is proportional to a differential value of a deformation amount of the piezoelectric film 14 due to stretching or compression.

The first electrode 15a is a signal electrode. Therefore, a detection signal is output from the first electrode 15a. In the present embodiment, the first electrode 15a is provided on the upper principal surface of the piezoelectric film 14. The first electrode 15a covers the entire upper principal surface of the piezoelectric film 14. The first electrode 15a includes an adhesive layer (not illustrated). The first electrode 15a is fixed to the upper principal surface of the piezoelectric film 14 by the adhesive layer.

The second electrode 15b is a ground electrode. The second electrode 15b is connected to a ground potential. The second electrode 15b is provided on the lower principal surface of the piezoelectric film 14. The second electrode 15b covers the entire lower principal surface of the piezoelectric film 14. The second electrode 15b includes an adhesive layer (not illustrated). The second electrode 15b is fixed to the lower principal surface of the piezoelectric film 14 by the adhesive layer.

The substrate 16 is provided on the first electrode 15a. The substrate 16 is deformed together with the piezoelectric film 14 by holding the piezoelectric film 14, the first electrode 15a, and the second electrode 15b. The substrate 16 has a sheet shape. The substrate 16 includes an upper principal surface and a lower principal surface. A length of the substrate 16 in the left-right direction is longer than a length of the substrate 16 in the front-back direction. The material of the substrate 16 is, for example, polyurethane or PET.

The bonding layer 18 fixes the piezoelectric film 14, the first electrode 15a, and the second electrode 15b to the substrate 16. More specifically, the bonding layer 18 is provided on the lower principal surface of the substrate 16. The bonding layer 18 covers the entire lower principal surface of the substrate 16. Furthermore, the bonding layer 18 covers the entire upper principal surface of the first electrode 15a. The bonding layer 18 bonds the first electrode 15a and the substrate 16. As a result, the deformation of the substrate 16 is transmitted to the piezoelectric film 14 through the bonding layer 18. The material of the bonding layer 18 is, for example, a double-sided tape, a thermosetting bonding adhesive, or a thermoplastic bonding adhesive.

The bonding layer 20 is provided on the upper principal surface of the substrate 16. The bonding layer 20 fixes the substrate 16 to the lower principal surface of the plate-shaped member 7. The material of the bonding layer 20 is, for example, a double-sided tape, a thermosetting bonding adhesive, or a thermoplastic bonding adhesive.

The first cured resin layer 17 is provided under the second electrode 15b. In the present embodiment, the first cured resin layer 17 is in contact with the second electrode 15b. Furthermore, the first cured resin layer 17 covers at least a part of the second electrode 15b as viewed in the up-down direction. In the present embodiment, the first cured resin layer 17 covers the entire second electrode 15b as viewed in the up-down direction.

Here, the first cured resin layer 17 is an adhesive layer of a carrier tape 100. Specifically, as illustrated in FIG. 4, the carrier tape 100 is attached to the lower principal surface of the second electrode 15b. The carrier tape 100 includes the first cured resin layer 17 and a substrate layer 101. The material of the first cured resin layer 17 is a UV cured resin. In an uncured state, the first cured resin layer 17 bonds the substrate layer 101 and the second electrode 15b. However, the substrate layer 101 is peeled off from the first cured resin layer 17 after the first cured resin layer 17 is cured. At this time, as illustrated in FIG. 3, the first cured resin layer 17 is not peeled off together with the substrate layer 101, and remains on the lower principal surface of the second electrode 15b.

### EFFECTS

According to the sensor 6, since the first cured resin layer 17 is provided under the second electrode 15b, the sensor 6 is reinforced. This improves the rigidity of the sensor 6.

According to the sensor 6, the manufacturing cost of the sensor 6 can be reduced. More specifically, the material of the first cured resin layer 17 is a cured resin. Therefore, the first cured resin layer 17 is an adhesive layer of the carrier tape 100. As described above, in the sensor 6, the first cured resin layer 17 which is a part of the existing carrier tape 100 is used as a reinforcement member. As a result, it is not necessary to provide a new reinforcement member for reinforcing the sensor 6. Therefore, according to the sensor 6, the manufacturing cost of the sensor 6 can be reduced.

According to the sensor 6, the sensitivity of the sensor 6 is improved. More specifically, since the first cured resin layer 17 is provided in the sensor 6, the rigidity of the sensor 6 is high. When the rigidity of the sensor 6 is high, deformation of the operation panel 2 is easily transmitted to the piezoelectric film 14. That is, in the sensor 6, since a deformation amount of the piezoelectric film 14 tends to be large, a voltage of the detection signal output from the piezoelectric film 14 tends to be large. Therefore, according to the sensor 6, the sensitivity of the sensor 6 is improved.

According to the sensor 6, the first cured resin layer 17 is provided under the second electrode 15b. As a result, a conductor and a resin inside the sensor 6 are protected by the first cured resin layer 17. As a result, deterioration of the conductor and the resin inside the sensor 6 due to moisture absorption is suppressed.

Note that the presence or absence of the first cured resin layer 17 can be confirmed by FT-IR analysis (Fourier transform infrared spectroscopy). Specifically, in a case where the material of the first cured resin layer 17 is a UV cured resin, when the sensor 6 is subjected to the FT-IR analysis, a peak indicating the UV cured resin appears in an analysis result.

### First Modification

Hereinafter, a sensor 6a according to a first modification will be described with reference to the drawing. FIG. 5 is a sectional view of the sensor 6a.

The sensor 6a is different from the sensor 6 in the shape of a first cured resin layer 17. The first cured resin layer 17 may cover a part of the second electrode 15b as viewed in the up-down direction. That is, a part of the first cured resin layer 17 may be peeled off together with a substrate layer 101, and a remaining part of the first cured resin layer 17 may remain on a lower principal surface of a second electrode 15b without being peeled off together with the substrate layer 101. Other structures of the sensor 6a are the same as those of the sensor 6, and thus description thereof is omitted. The sensor 6a can achieve the same operation and effect as the sensor 6.

### Second Modification

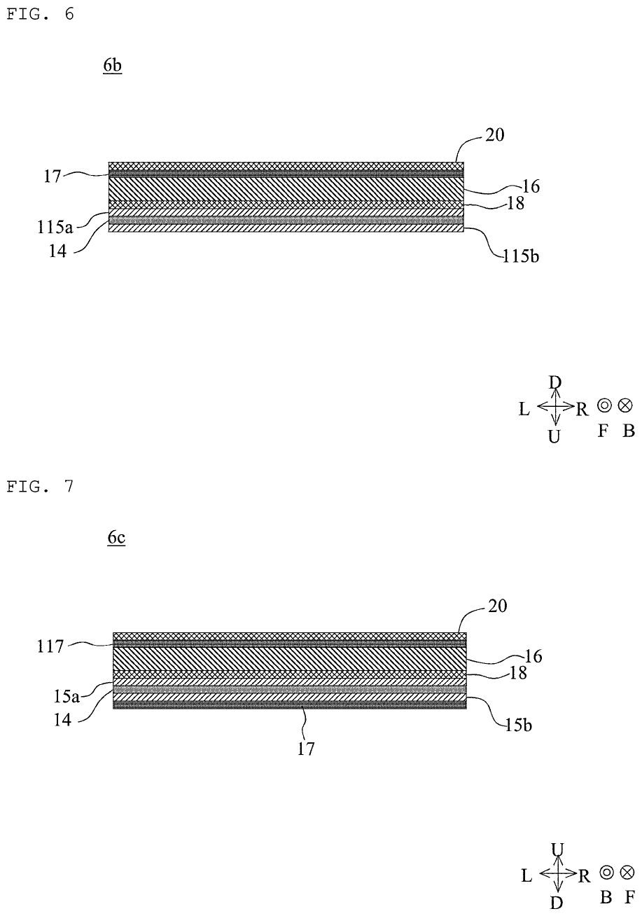

Hereinafter, a sensor 6b according to a second modification will be described with reference to the drawing. FIG. 6 is a sectional view of the sensor 6b.

The sensor 6b is different from the sensor 6 in that an up-down direction is inverted and in a position of a first cured resin layer 17. More specifically, the up-down direction of the sensor 6b is opposite to the up-down direction of the sensor 6. Therefore, in the sensor 6b, a first electrode 115b is located on a piezoelectric film 14. The first electrode 115b is connected to a ground potential. The second electrode 115a is located under the piezoelectric film 14. A detection signal is output from the second electrode 115a. The first cured resin layer 17 is provided under the second electrode 115a. The first cured resin layer 17 is located between a substrate 16 and a bonding layer 20. Since other structures of the sensor 6b are the same as those of the sensor 6, the description thereof will be omitted. The sensor 6b can achieve the same operation and effect as the sensor 6.

### Third Modification

Hereinafter, a sensor 6c according to a third modification will be described with reference to the drawing. FIG. 7 is a sectional view of the sensor 6c.

The sensor 6c is different from the sensor 6 in further including a second cured resin layer 117. The second cured resin layer 117 is provided on a first electrode 15a. The second cured resin layer 117 is located between a substrate 16 and a bonding layer 20. Other structures of the sensor 6c are the same as those of the sensor 6, and thus description thereof is omitted. The sensor 6c can achieve the same operation and effect as the sensor 6.

### Other Embodiments

The sensor according to the present disclosure is not limited to the sensors 6 and 6a to 6c, and can be changed within the scope of the gist thereof. Furthermore, the structures of the sensors 6 and 6a to 6c may be arbitrarily combined.

Note that, in the electronic device 1, the piezoelectric film 14 may be a polyvinylidene fluoride (PVDF) film. Furthermore, the piezoelectric film 14 may be piezoelectric ceramic. Furthermore, the piezoelectric film 14 may be a strain sensor.

Note that the bonding member 5 may not have waterproofness.

Note that two sides extending in the front-back direction may be short sides, and two sides extending in the left-right direction may be long sides.

Note that the sensor 6 may be provided at a position other than the center in the front-back direction of the plate-shaped member 7 when viewed in the up-down direction.

Note that the operation panel 2 may be a resin plate.

Note that the sensor 6 may not have a longitudinal direction extending in the left-right direction. The sensor 6 may have a longitudinal direction extending in the front-back direction.

Note that the electronic device 1 includes the touch panel, but may be a touch pad. In this case, the display panel 4 is unnecessary. Furthermore, the operation panel 2 may not be a transparent member.

Note that the material of the first cured resin layer 17 may be a cured resin other than the UV cured resin. The material of the first cured resin layer 17 may be, for example, a thermosetting resin.

### DESCRIPTION OF REFERENCE SYMBOLS

1: Electronic device
2: Operation panel
3: Housing
4: Display panel
5: Bonding member
6, 6a to 6c: Sensor
7: Plate-shaped member
14: Piezoelectric film
15a, 115b: First electrode
15b, 115a: Second electrode
16: Substrate
17: First cured resin layer
117: Second cured resin layer
18, 20: Bonding layer
100: Carrier tape
101: Substrate layer

1. A sensor comprising:
a piezoelectric film including an upper principal surface and a lower principal surface aligned in an up-down direction;
a first electrode on the upper principal surface of the piezoelectric film;
a second electrode on the lower principal surface of the piezoelectric film; and
a first cured resin layer covering at least a part of the second electrode as viewed in the up-down direction.

2. The sensor according to claim 1, wherein
the second electrode is connected to a ground potential, and
the first electrode is constructed to output a detection signal.

3. The sensor according to claim 1, wherein the first cured resin layer covers entirety of the second electrode as viewed in the up-down direction.

4. The sensor according to claim 1, wherein the first cured resin layer covers a part of the second electrode as viewed in the up-down direction.

5. The sensor according to claim 1, wherein the first cured resin layer is in contact with the second electrode.

6. The sensor according to claim 1, wherein a material of the first cured resin layer is a UV cured resin.

7. The sensor according to claim 1, further comprising a second cured resin layer on the first electrode.

8. The sensor according to claim 7, wherein the second cured resin layer is on a side of the first electrode opposite to the piezoelectric film and the second electrode.

9. The sensor according to claim 1, wherein
the first electrode is connected to a ground potential, and
the second electrode is constructed to output a detection signal.

10. The sensor according to claim 1, wherein the piezoelectric film is constructed such that a polarity of a charge generated by the piezoelectric film when the piezoelectric film is stretched in a left-right direction is different from a polarity of a charge generated by the piezoelectric film when the piezoelectric film is stretched in a front-back direction.

11. The sensor according to claim 1, wherein the piezoelectric film comprises polylactic acid.

12. The sensor according to claim 1, further comprising a substrate on the first electrode.

13. The sensor according to claim 1, wherein the first cured resin layer is on a side of the second electrode opposite to the piezoelectric film and the first electrode.

14. The sensor according to claim 1, wherein the first cured resin layer is on a same side of the second electrode as the piezoelectric film and the first electrode.

15. An electronic device comprising:
an operation panel; and
the sensor according to claim 1 fixed to the operation panel so as to detect deformation of the operation panel.

16. The electronic device according to claim 15, further comprising a display panel between the operation panel and the sensor.

17. The electronic device according to claim 16, further comprising a plate-shaped member between the display panel and the sensor.

18. The electronic device according to claim 15, wherein the sensor is located at a center of the operation panel.
